(19) United States
(12) Patent Application Publication
(10) Pub. No.: US 2021/0198050 A1
(43) Pub. Date: Jul. 1, 2021

(54) PRIMARY BELT CLEANER TENSIONING SYSTEM WITH INTERNAL TORSION SPRING

(71) Applicant: ASGCO Manufacturing, Inc., Allentown, PA (US)

(72) Inventor: Andrew M. COLLIER, Whitehall, PA (US)

(21) Appl. No.: 17/134,617

(22) Filed: Dec. 28, 2020

Related U.S. Application Data
(60) Provisional application No. 62/954,769, filed on Dec. 30, 2019.

(51) Int. Cl. B65G 45/16

(52) U.S. Cl. CPC B65G 45/16

(57) ABSTRACT

A primary belt cleaner tensioning system that permits the adjustment of contacting force of a scraper blade on a conveyor belt surface. The system utilizes a torsion spring contained within a mounting tube and rotatable shaft which not only protects the torsion spring from the environment but also allows the spring length to be sufficiently long to have enhanced deflection during tensioning. As the blade wears and tension is released, a significant amount of the initially-applied tension is retained in the system, thereby eliminating the need to retension the system over the life of the blade as is required for prior art blade tensioning systems. A tension applicator allows the user to initially tension the system and use of shaped retainers and end caps allow one end of the torsion spring to be fixed to different types of hollow shafts while the other end is coupled to the tension applicator.

### CROSS-REFERENCE TO RELATED APPLICATIONS

This non-provisional application claims the benefit under 35 U. S.C. § 119(e) of Application Ser. No. 62/954,769 filed on Dec. 30, 2019 entitled PRIMARY BELT CLEANER TENSIONING SYSTEM WITH INTERNAL TORSION SPRING and whose entire disclosure is incorporated by reference herein.

### BACKGROUND OF THE INVENTION

The present invention relates to a tensioning device for adjusting the force with which the blade of a conveyor belt scraper contacts the conveyor belt surface, and more particular, to a belt cleaner tensioning device that utilizes an internal torsion spring.

U.S. Pat. No. 5,201,402 (Mott), assigned to ASGCO Manufacturing, Inc., Assignee of the present application (and which is incorporated by reference herein in its entirety), describes a tensioning device for adjusting the contacting force of a scraper blade on an endless conveyor belt. The tensioning device described therein is a rotary tensioner which adjusts the contacting force of the scraper blade on the conveyor belt surface by controlling the torque exerted on a rotatable shaft that supports the scraper blade. To that end a tensioning collar and an adjustment collar are disposed adjacent to one another on the support shaft. The adjustment collar is fixed to and rotates with the support shaft. The tensioning collar is attached to one end of a torsional bias mechanism such as a coil spring. The other end of the bias mechanism is fixed to the conveyor belt frame. Each collar has a series of holes formed therethrough, the holes being arrayed at a selected radial distance from the axis of the support shaft. As the collars are rotated relative to each other, the torsional bias on the support shaft is increased or decreased, and the holes on one collar move into and out-of axial alignment with the holes on the other collar. Each series of holes has different spacing between respective holes so that the torsional bias can be adjusted in very small increments. The collars are locked into relative position by the insertion of a lock-pin through two aligned holes. FIG. 1 depicts a view of the blade scraper tensioning device of U.S. Pat. No. 5,201,402 (Mott).

Although the known device works well, in practice it was found that adjustment of the torsional bias of the tensioning device requires the efforts of two persons. In the arrangement described in the aforesaid patent, one hand is necessary to rotate the tensioning collar and a second hand is necessary to hold the scraper blade in engagement with the conveyor belt surface by rotating the support shaft. The latter operation is usually performed by rotating the adjustment collar in a direction counter to that of the tensioning collar. A third hand is then necessary to insert the locking pin through the aligned holes in the collars because the first two hands must be used to maintain the two collars in proper alignment.

To address the above concerns, among other things, Applicant obtained U.S. Pat. No. 5,992,614 (Mott), whose entire disclosure is also incorporated by reference herein. This patent discloses a tensioning device for adjusting the contacting/cleaning force of a scraper blade on the surface of an endless conveyor belt which is provided on a shaft supporting the scraper blade. This tensioning device allows the shaft to be rotated and locked in position which is very close to its optimum cleaning position, thereby increasing the efficiency of the scraper assembly. FIG. 2 depicts a view of the blade scraper tensioning device of U.S. Pat. No. 5,992,614 (Mott).

However, in both of these devices, designing a large belt width/blade wear cleaner requires a lot of force to tension. Typically compression springs can give the tension but compression springs lose tension quickly. To size a torsion spring to tension the cleaner, which holds tension better than a compression spring, it would need to be very long in length. This is problematic in typical conveyor applications because the areas around the pulleys where these cleaners are used are constricted due to bearings, motors, structure, etc.

Thus, there remains a need for a conveyor blade scraper tensioning device that does not require re-tensioning through its blade life and which is protected from the environment.

All references cited herein are incorporated herein by reference in their entireties.

### BRIEF SUMMARY OF THE INVENTION

A conveyor belt cleaning device for adjusting the contacting force of a scraper blade on the surface of an endless conveyor belt mounted in a support structure is disclosed. The conveyor belt cleaning device comprises: a scraper blade mounted to a hollow shaft that is rotatable, wherein the shaft comprises mounting brackets on each shaft end for positioning the conveyor belt cleaning device in a transverse orientation at the conveyor belt; and a tensioning apparatus coupled to the shaft for controlling the amount of tension to be provided to the shaft for tensioning the scraper blade against the endless conveyor belt, and wherein the tensioning apparatus comprises a tension applicator (e.g., a worm/worm gear assembly, a ratcheting gear/pawl assembly, etc.) coupled to a tension spring secured inside the hollow shaft; and wherein the tensioning apparatus permits the scraper blade to be utilized through its entire life span without having to re-tension said tensioning apparatus.

A method of cleaning an endless conveyor belt using a scraper blade whose contacting force on the surface of the belt mounted can be adjusted is disclosed. The method comprises: positioning the scraper blade on a hollow rotatable shaft in an orientation that is transverse to conveyor belt motion; applying an initial tension to the hollow rotatable shaft via a torsion spring that is contained within the hollow rotatable shaft, and wherein the applied initial tension biases the scraper blade against the surface of the belt while eliminating the need to re-tension the scraper blade over a life of the scraper blade.

### BRIEF DESCRIPTION OF SEVERAL VIEWS OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is an isometric view of a prior art conveyor blade scraper tensioning device disclosed in U.S. Pat. No. 5,201,402 (Mott);

FIG. 2 is an isometric view of another prior art conveyor blade scraper tensioning device disclosed in U.S. Pat. No. 5,992,614 (Mott);

FIG. 3 is an isometric view of the primary belt cleaner tensioning system of the present invention;

FIG. 4 is end view of the primary belt cleaner tensioning system taken along line 4-4 of FIG. 3;

FIG. 4A is a side view of the primary belt cleaner tensioning system in position against a head pulley for cleaning a conveyor belt;

FIG. 5 is a partial longitudinal cross-sectional view of the invention taken along line 5-5 of FIG. 4;

FIG. 6 is a partial longitudinal view of the invention taken along line 6-6 of FIG. 3;

FIG. 7 is a cross-sectional view of the invention taken along line 7-7 of FIG. 6;

FIG. 8 is a cross-sectional view of the invention taken along line 8-8 of FIG. 6;

FIG. 9A is a comparison chart of two prior art spring-torsioned blade cleaning systems (CSTS and STSTS) versus the present invention (“system 20”) where retensioning occurs at 0 tension remains in system;

FIG. 9B is a comparison chart of the two prior art systems (CSTS and STSTS) versus the present invention (“system 20”) where retensioning occurs at 50% tension remains in system;

FIG. 10A is an enlarged view of an exemplary worm/worm gear portion of the tensioning system of the primary belt cleaner tensioning system, similar to the view of FIG. 8;

FIG. 10B is a partial cross-sectional view of the worm/worm gear portion taken along line 10B-10B of FIG. 10A;

FIG. 10C is an end view of the second retainer taken along line 10C-10C of FIG. 10B;

FIG. 10D is a partial cross-sectional view of the second retainer taken along line 10D-10D of FIG. 10C;

FIG. 11A is a similar end view of another retainer that is rounded for use in a rounded tube;

FIG. 11B is a partial cross-sectional view of the rounded retainer of FIG. 11A taken along line 11B-11B of FIG. 11A;

FIG. 12A is a cross-sectional view of another round retainer taken along line 12A-12A of FIG. 12B;

FIG. 12B is a partial cross-sectional view of another round retainer taken along line 12B-12B of FIG. 12A;

FIG. 13A is a partial cross-sectional view of a further round retainer whose far end is coupled to the tensioning apparatus;

FIG. 13B is a partial cross-sectional view of the round retainer of FIG. 13A;

FIG. 14A is a partial cross-sectional view of even a further round retainer whose near end is coupled to the tensioning apparatus;

FIG. 14B is a partial cross-sectional view of the round retainer of FIG. 14A;

FIG. 15A is an enlarged view of an exemplary ratcheting gear and pawl of the tensioning system of the primary belt cleaner tensioning system; and

FIG. 15B is a partial cross-sectional view of the ratcheting gear and pawl portion taken along line 15B-15B of FIG. 15A.

### DETAILED DESCRIPTION OF THE PREFERRED EMBODIMENTS

Referring now to the figures, wherein like reference numerals represent like parts throughout the several views, exemplary embodiments of the present disclosure will be described in detail. Throughout this description, various components may be identified having specific values, these values are provided as exemplary embodiments and should not be limiting of various concepts of the present invention as many comparable sizes and/or values may be implemented.

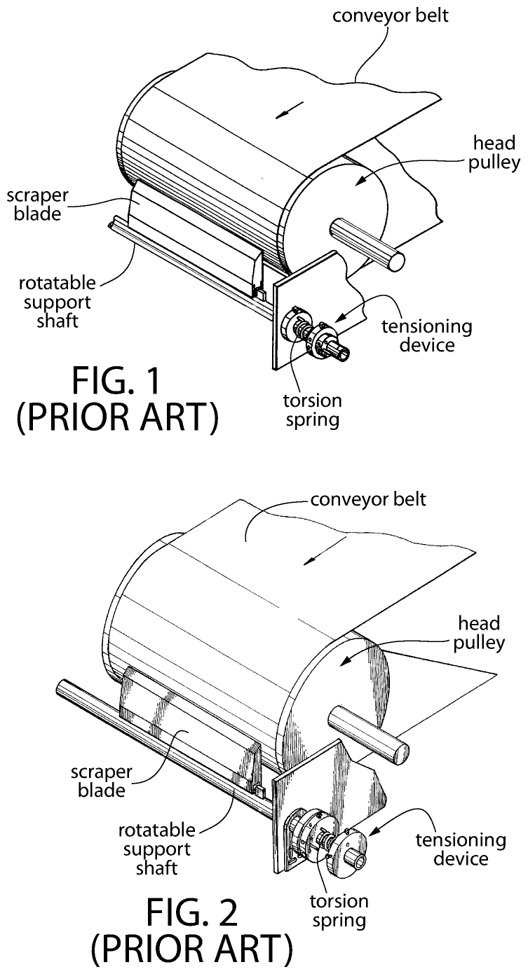

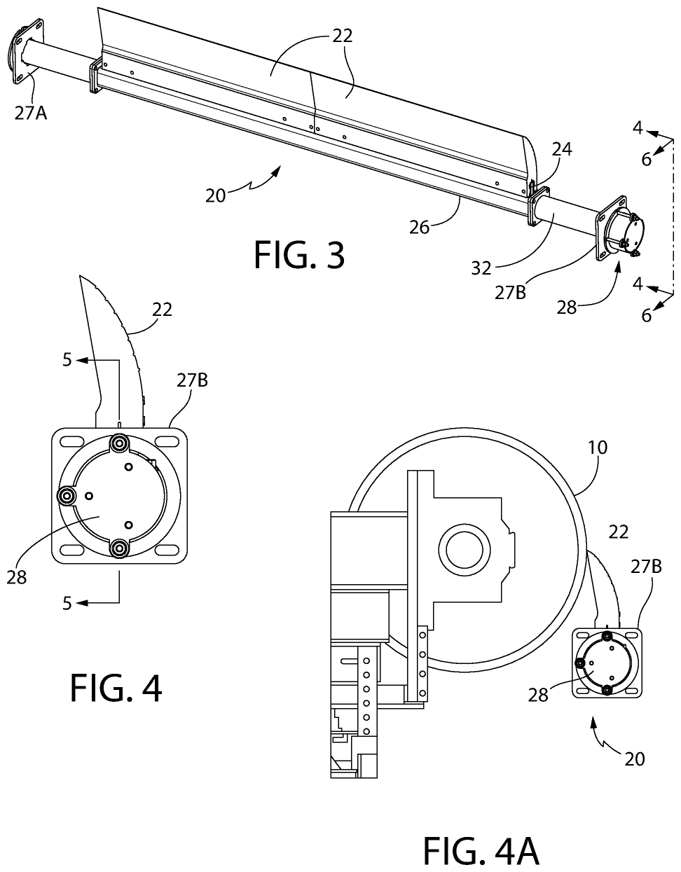

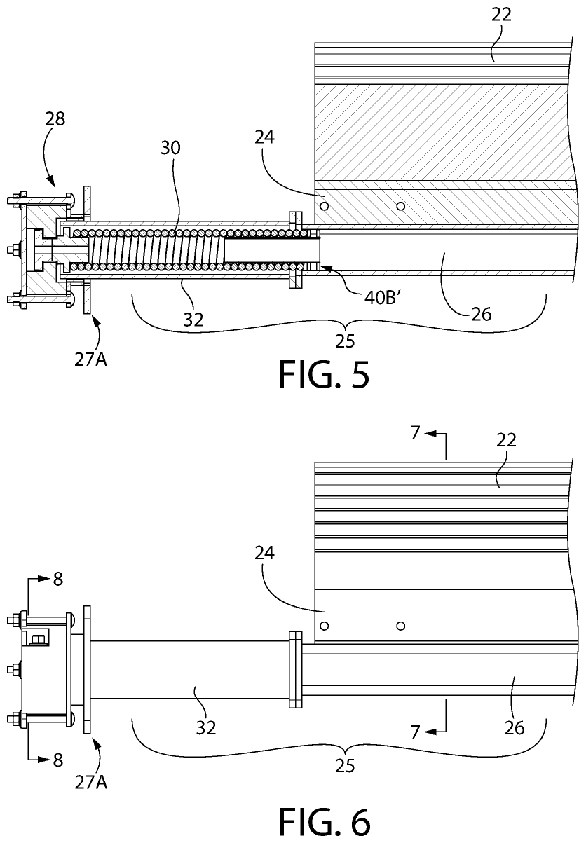

As shown in FIG. 3, the primary belt cleaner tensioning system 20 comprises at least one scraper blade 22 mounted on a support arm 24 which is fixed to a rotatable, transverse hollow shaft 26. A pair of mounting brackets 27A/27B permit the invention 20 to be mounted to conveyor belt supporting structure (not shown) such that the invention 20 is oriented transversely to the conveyor belt motion. Unlike the tensioning apparatus of the prior art systems (FIGS. 1 and 2), the tensioning apparatus of the present invention 20 comprises a tension applicator 28 (e.g., a worm/worm gear, a pawl/ratcheting gear, etc.) coupled to a torsion spring 30 (see FIG. 5) that is positioned inside an enclosure 25 (e.g., a mounting tube 32 and hollow shaft 26 together forming the enclosure 25, as shown most clearly in FIG. 5). By positioning the torsion spring 30 internally of the enclosure 25, this permits the spring 30 to be longer than the springs used in the prior art systems. In particular, as shown in FIGS. 1-2, the springs used therein are of short lengths in order to be accommodated within the constricted space having motors, structure, etc., therein. In contrast, the longer torsion spring 30 used in the present invention 20 permits it to make more deflection to configure the spring 30 to have the requisite tension (e.g., much like a garage door spring) because the more spring deflection, the more rotation. Belt cleaners, in general, operate by rotating the blade into a conveyor belt head pulley 10 (FIG. 4A) and it continues to rotate as the blade 22 wears. Thus, by having a longer spring 30, more tension is retained on the blade 22 as it rotates due to blade wear. Moreover, if the spring 30 needs to be made even longer, that option is available due to the open space in the shaft 26. The upshot of this particular torsion spring 30 configuration is that the blade's 22 cleaning effectiveness is greatly enhanced since the majority of the initial tension applied to the spring 30 is retained, thereby giving the system 20 a much better belt cleaning effectiveness, throughout the blade's 22 life. By way of example only, the terms “long” or “longer” when comparing spring 30 to shorter springs used in the prior art, mean springs that are 10 inches in length or longer.

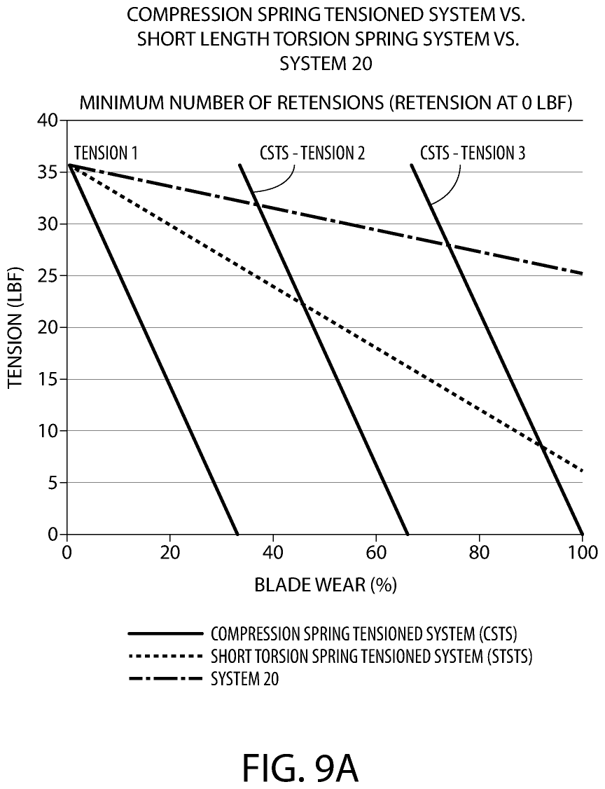

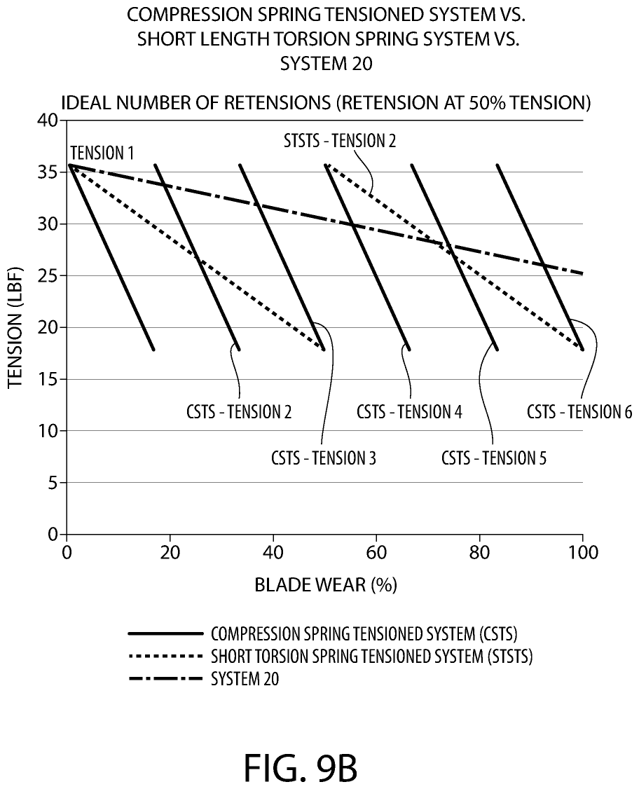

This can be best seen in the charts shown in FIGS. 9A-9B. In FIG. 9A, the first prior art system, compression spring tensioned system (CSTS), two retensionings over the life of the blade are required since the tension in that system falls to zero twice in the blade's life. Furthermore, in the second prior art system, short length torsion spring system (STSTS), although no retensioning is required, so much tension has been lost, that the cleaning efficiency of the STSTS has been highly compromised. In contrast, the present invention (system 20) retains a significant amount of the initially-applied tension, thereby retaining a better cleaning effectiveness on the conveyor belt over both prior art systems. FIG. 9B provides another demonstration of the higher cleaning effectiveness of the present invention 20 over the prior systems even when the retentioning occurs at 50% of original tension. As can be seen in FIG. 9B, the CSTS requires five retensionings over the life of the blade, while, the STSTS requires two retentionings. In contrast, the present invention 20 requires no retentioning and retains a significant amount of the initially-applied tension over the life (or “life span”) of the blade 22.

By way of example only, the following provides a comparison of the torsion spring deflection between prior art devices and of the present invention, with the understanding that the blade rotates 30° from the start of a new blade 22 installation (FIG. 4A) until the blade requires replacement:

| | New Blade | Worn Blade |
|---|---|---|
| Torsion System | Deflection/Tension | Deflection/Tension |
| Prior Art Devices | 30°/100 lbs. tension | 0°/0 lbs. tension |
| Present Invention | 100°/100 lbs tension | 70°/70 lbs tension |

As can be seen by the above chart, using the present invention 20, when the blade is worn and needs replacement, a significant amount of tension (e.g., 70 lbs) remains stored in the torsion spring 30, thereby eliminating the need to re-tension the spring 30. In contrast, in the prior art devices, since all of the tension energy has dissipated at the time of blade wear, the springs in those systems require re-tensioning. As a result, the present invention 20 eliminates the need to re-tension the system 20 over the life of the blade 22 as compared to prior art tensioned blade systems which require re-tensioning because so much of the initially-applied tension is dissipated in a shorter amount of time. Moreover, because the spring 30 is completely enclosed within the mounting tube 32 and shaft 26, it is also protected from the environment.

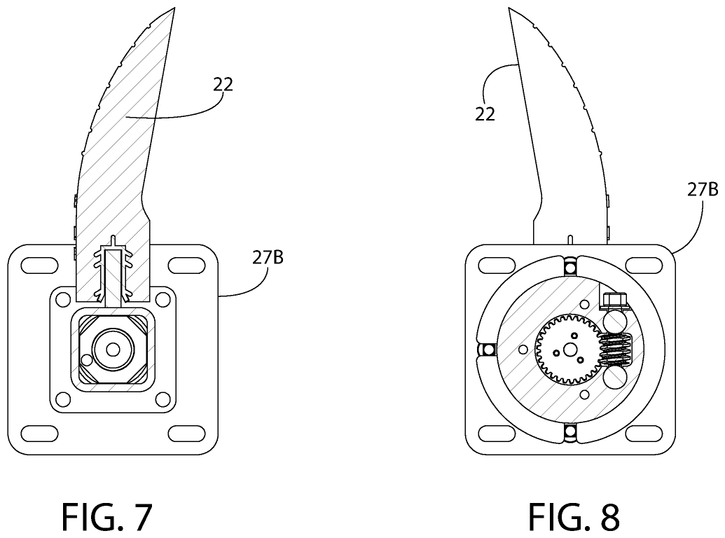

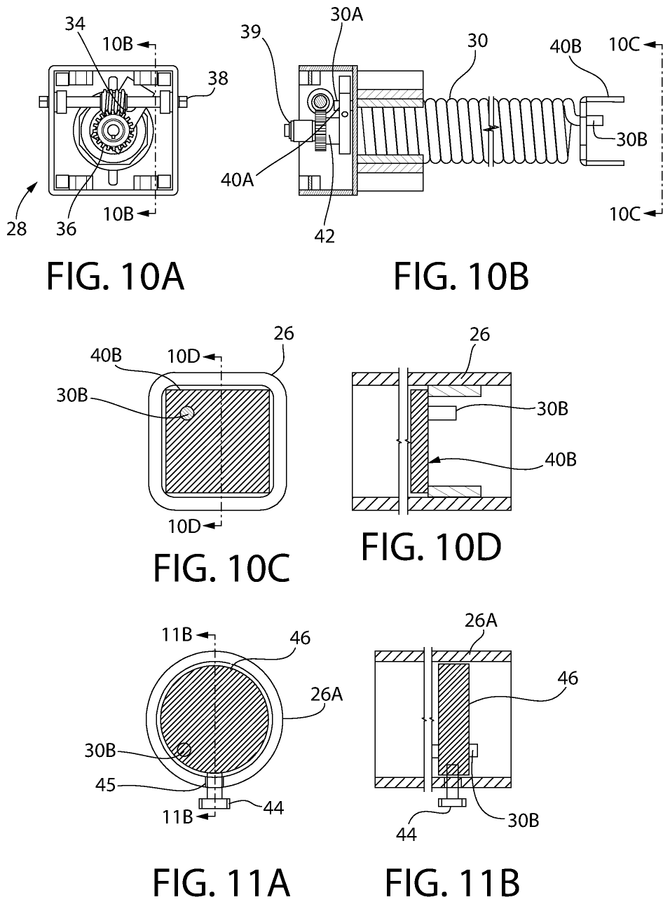

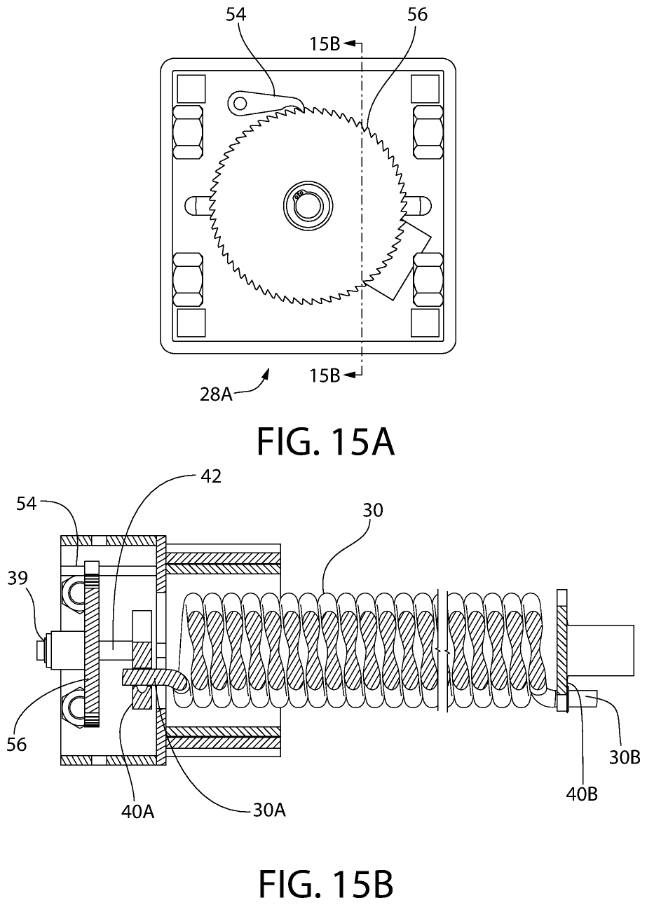

FIGS. 10A-15B depict various exemplary tensioning/spring retention configurations which may form tension applicator 28. It should be noted that although the housing of the tension applicator 28 is depicted as being a rounded square configuration in FIGS. 10A-10C and in FIGS. 15A-15B in contrast to the circular housing of the tension applicator 28 depicted in FIGS. 1-8, this does not affect the operation of the various tensioning/spring retention configurations depicted in FIGS. 10A-15B.

In FIGS. 10A-10D, a worm 34 and worm gear 36 tension applicator 28 is provided to control spring tensioning via a tensioning shaft 38 for controlling worm 34 rotation and an idler shaft 39 for controlling worm gear 36 rotation. One end of the spring 30 (viz., spring tang 30A) is fixed in a first spring retainer 40A which is attached to the worm gear 36 for transmitting torsion from a tension shaft 42 to the spring 30. The other end (viz., spring tang 30B) of the spring 30 is fixed within a second retainer 40B that secured within the shaft 26; for example, a corresponding second retainer 40B′ is shown in FIG. 5 that secures the spring tang 30B in the shaft 26, although the tang 30B is hidden by the retainer 40B′ shown in FIG. 5. It should be noted that the second retainers 40B and 40B′ comprise a square configuration that fits snugly within the hollow shaft 26 which is also of a square contour (see FIG. 3). As such, set screws are not required since the square retainer 40A is unable to rotate within the square-shaped shaft 26, as shown in FIGS. 10C-10D. Moreover, it should be understood that the term “square” as used in this Specification with regard to the hollow shaft 26 and components coupled thereto is being used to cover all quadrilateral cross-sectional shapes, such as rectangles also.

Alternatively, if a round hollow rotatable shaft 26A were used, as shown in FIGS. 11A-11B, then set screws 44 could be used to prevent rotation. In particular, the retainer 46 is circular in contour and is thus referred to as a “round retainer” 46; as such, all subsequent use of the term “round retainer” or “round rotating retainer” means circular in contour. The round retainer 46 has a diameter that is slightly smaller than the internal diameter of the hollow shaft 26A and is inserted into the round hollow shaft 26A. The round retainer 46 holds spring tang 30B and is prevented from rotation within the round hollow shaft 26A by set screw 44 that pass through an aperture 45 in the round hollow rotatable shaft 26A in a radial direction, as shown.

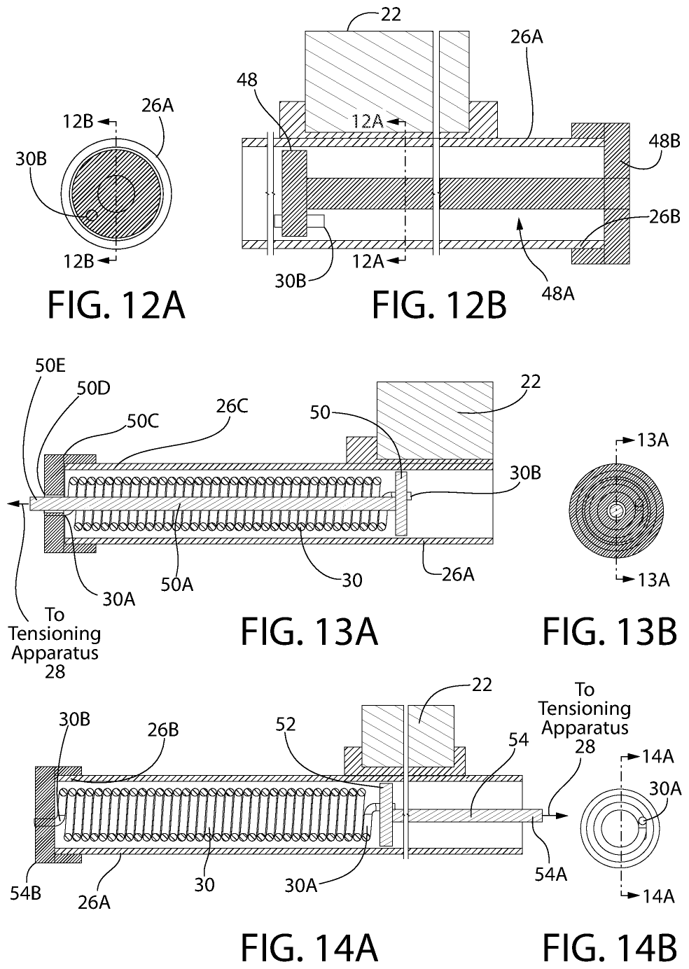

Moreover, a further alternative to securing the spring tang 30B inside a round shaft 26 is shown in FIGS. 12A-12B. In this alternative, a round retainer 48, which holds the spring tang 30B, comprises an extension 48A and a round end cap 48B; the round end cap 48B has a diameter that is slightly larger than the round hollow rotatable shaft 26A in order to fit over the end of the shaft 26A. Conversely, the round retainer 48 has a diameter that is slightly smaller than the internal diameter of the hollow shaft 26A. The extension 48A is orthogonal to both the retainer 48 and the end cap 48B and is of sufficient length to allow the end cap 48B to secure to the opposite end 26B (i.e., the end that is opposite of the tension applicator 28) of round shaft 26A. The end cap 48B can also be mechanically secured to the end 26B (e.g., fasteners such as bolt, set screw, etc.) to secure the retainer 48A in place relative to the round shaft 26.

FIGS. 13A-13B depict another tensioning/spring retention configurations whereby the end 30A of the spring 30 closest to the tensioning apparatus 28 is fixed while the opposite end 30B of the spring is driven by the tensioning apparatus 28. In particular, a round rotating retainer 50 holds one end 30B of the spring 30 therein. An extension 50A, coupled orthogonally at one end to the round rotating retainer 50, is positioned through the torsion spring 30 in parallel to the spring axis and passes through an aperture 50D in the end round retainer 50C that is positioned over the end of the round shaft 26A (the end round retainer 50C has a diameter slightly larger than the round shaft 26A). The other end 50E of the extension 50A is coupled to the tensioning apparatus 28. The end round retainer 50C also holds the other end 30A of the torsion spring 30 therein; the end retainer 50C is also mechanically secured to the end 26C of the shaft 26A (e.g., fasteners such as bolt, set screw, etc.). Thus, during operation, the tension applicator 28 introduces torsion into the spring 30 by rotating spring end 30B and consequently round retainer 50 (which has a diameter that is slightly smaller than the internal diameter of the hollow shaft 26A, thereby allowing the retainer 50 to rotate within the shaft 26A) while the other end 30A is held fixed.

Another alternative tensioning/spring retention configuration is shown in FIGS. 14A-14B. In this configuration, a round rotating retainer 52 (which also has a diameter that is slightly smaller than the internal diameter of the hollow shaft 26A, thereby allowing the retainer 52 to rotate within the shaft 26A) holds the end 30A of torsion spring 30 therein and includes an extension 54 having an end 54A that is connected to the tension applicator 28; the extension 54 is also orthogonal to the retainer 52. A separate end round retainer 54B is mechanically secured (e.g., fasteners such as bolt, set screw, etc.) to the opposite end 26B of the shaft 26A and holds the other end 30B of the torsion spring 30. As with the other end round retainers, the retainer 54B comprises a diameter slightly larger than the shaft 26A to fit thereover.

Another alternative 28A for the tension applicator 28 itself is shown in FIGS. 15A-15B. In this alternative, a pawl 54 and ratcheting gear 56 are used to apply tension. All of the other aspects of this particular tension applicator 28A operate similarly as described with regard to the worm/worm gear configuration discussed above with regards to FIGS. 10A-10B.

Thus, with the torsion spring 30 positioned within the hollow shaft (26 or 26A), the tensioning apparatus is much more compact which is important because the available space for these types of conveyor blade cleaners is very tight and this “additional space” permits the use of a longer torsion spring 30 while also protecting the spring 30 from the harsh external environment.

While the invention has been described in detail and with reference to specific examples thereof, it will be apparent to one skilled in the art that various changes and modifications can be made therein without departing from the spirit and scope thereof.

What is claimed is:

1. A conveyor belt cleaning device for adjusting the contacting force of a scraper blade on the surface of an endless conveyor belt mounted in a support structure, said conveyor belt cleaning device comprising:
a scraper blade mounted to a hollow shaft that is rotatable, said shaft comprising mounting brackets on each shaft end for positioning said conveyor belt cleaning device in a transverse orientation at the conveyor belt; and
a tensioning apparatus coupled to said shaft for controlling the amount of tension to be provided to said shaft for tensioning said scraper blade against the endless conveyor belt, said tensioning apparatus comprising a tension applicator coupled to a tension spring secured inside said hollow rotatable shaft; and
wherein said tensioning apparatus permits the scraper blade to be utilized through its entire life span without having to re-tension said tensioning apparatus.

2. The conveyor belt cleaning device of claim 1 wherein said tension applicator is coupled to a first end of said torsion spring using a first retainer and wherein a second end of said torsion spring is coupled to a second retainer that is secured within said hollow rotatable shaft.

3. The conveyor belt cleaning device of claim 2 wherein said hollow rotatable shaft is square in cross-section and wherein said second retainer is square in contour for securing said second retainer within said hollow rotatable shaft to prevent relative motion between said retainer and said hollow rotatable shaft.

4. The conveyor belt cleaning device of claim 2 wherein said tension applicator comprises a worm/worm gear assembly and a tension shaft having a first end and a second end, said first end being coupled to said worm/worm gear assembly and said second end being secured to a second retainer that holds said first end of said torsion spring.

5. The conveyor belt cleaning device of claim 2 wherein said tension applicator comprises a ratcheting gear/pawl assembly and a tension shaft having a first end and a second end, said first end being coupled to said ratcheting gear/pawl assembly and said second end being secured to a second retainer that holds said first end of said torsion spring.

6. The conveyor belt cleaning device of claim 1 wherein said hollow rotatable shaft is circular in cross-section and wherein a first end of said torsion spring is secured to a first retainer that is circular in contour and wherein a second end of said torsion spring is secured to a second retainer that is also circular in contour and wherein one of said retainers is fixed to said hollow rotatable shaft and the other one of said retainers is coupled to said tension applicator.

7. The conveyor belt cleaning device of claim 6 wherein said first retainer is positioned within said hollow rotatable shaft and a fastener is passed in a radial direction through an aperture in said hollow rotatable shaft to fix said first retainer to said hollow rotatable shaft and wherein said second retainer is coupled to said tension applicator.

8. The conveyor belt cleaning device of claim 6 wherein said first retainer comprises an extension with an end cap at one end thereof and wherein said end cap is secured to an end of said hollow rotatable shaft that is opposite to said end of said hollow rotatable shaft where said tension applicator is positioned and wherein said second retainer is coupled to said tension applicator.

9. The conveyor belt cleaning device of claim 6 wherein said first retainer is secured to one end of said hollow rotatable shaft where said tension applicator is positioned and wherein said second retainer is positioned within said hollow rotatable shaft, and wherein said second retainer comprises an extension that is orthogonal to said second retainer and comprises an end that passes through an aperture in said first retainer and wherein said end that passes through said aperture is coupled to said tension applicator.

10. The conveyor belt cleaning device of claim 6 wherein said first retainer is secured to one end of said hollow rotatable shaft that is opposite an end of said hollow rotatable shaft where said tension applicator is located and wherein said second retainer is positioned within said hollow rotatable shaft, said second retainer comprising an extension that is orthogonal to said second retainer and which has an end that couples to said tension applicator.

11. The conveyor belt cleaning device of claim 6 wherein said tension applicator comprises a worm/worm gear assembly that couples to either said first retainer or to said second retainer.

12. The conveyor belt cleaning device of claim 6 wherein said tension applicator comprises a ratcheting gear/pawl assembly that couples to either said first retainer or to said second retainer.

13. A method of cleaning an endless conveyor belt using a scraper blade whose contacting force on the surface of the belt mounted can be adjusted, said method comprising:
positioning said scraper blade on a hollow rotatable shaft in an orientation that is transverse to conveyor belt motion;
applying an initial tension to said hollow rotatable shaft via a torsion spring that is contained within said hollow rotatable shaft, said applied initial tension biasing said scraper blade against the surface of the belt while eliminating the need to re-tension said scraper blade over a life of said scraper blade.

14. The method of claim 13 wherein said step of applying an initial tension comprises:
coupling a first end of said torsion spring to a tension applicator located at one end of said hollow rotatable shaft; and
positioning a second end of said torsion spring within said hollow rotatable shaft.

15. The method of claim 14 wherein said step of coupling the second end comprises:
forming said hollow rotatable shaft to be square in cross-section;
securing said second end of said torsion spring to a retainer that is also square in contour for securing said retainer within said rotatable shaft to prevent relative motion between said retainer and said hollow rotatable shaft.

16. The method of claim 15 wherein said step of coupling the first end of said torsion spring to a tension applicator comprises coupling a first end of a tension shaft to a worm/worm gear assembly and coupling a second end of said tension shaft to a second retainer that holds said first end of said torsion spring.

17. The method of claim 15 wherein said step of coupling the first end of said torsion spring to a tension applicator comprises coupling a first end of a tension shaft to a ratcheting gear/pawl assembly and coupling a second end of said tension shaft to a second retainer that holds said first end of said torsion spring.

18. The method of claim 13 wherein said step of applying an initial tension comprises:
forming said hollow rotatable shaft to be circular in cross-section;
securing a first end of said torsion spring to a first retainer that is circular in contour and a securing a second end of said torsion spring to a second retainer that is also circular in contour; and
fixing one of said retainers to said hollow rotatable shaft and coupling the other one of said retainers to said tension applicator.

19. The method of claim 18 wherein said step of fixing one of said retainers to said hollow rotatable shaft comprises positioning said first retainer within said hollow rotatable shaft and passing a fastener in a radial direction through an aperture in said hollow rotatable shaft to fix said first retainer to said hollow rotatable shaft while coupling said second retainer to said tension applicator.

20. The method of claim 18 wherein step of fixing one of said retainers to said hollow rotatable shaft comprises forming said first retainer to have an extension with an end cap at one end thereof, said end cap configured to secure to an end of said hollow rotatable shaft that is opposite to said end of said hollow rotatable shaft where said tension applicator is positioned and wherein said second retainer is coupled to said tension applicator.

21. The method of claim 18 wherein step of fixing one of said retainers to said hollow rotatable shaft comprises securing said first retainer to one end of said hollow rotatable shaft where said tension applicator is located and positioning said second retainer within said hollow rotatable shaft, said second retainer comprising an extension that is orthogonal to said second retainer and which has an end that passes through an aperture in said first retainer and which couples to said tension applicator.

22. The method of claim 18 wherein step of fixing one of said retainers to said hollow rotatable shaft comprises securing said first retainer to one end of said hollow rotatable shaft that is opposite an end of said hollow rotatable shaft where said tension applicator is located and positioning said second retainer within said hollow rotatable shaft, said second retainer comprising an extension that is orthogonal to said second retainer and which has an end that couples to said tension applicator.

23. The method of claim 18 wherein said tension applicator comprises a worm/worm gear assembly that couples to either said first retainer or to said second retainer.

24. The method of claim 18 wherein said tension applicator comprises a ratcheting gear/pawl assembly that couples to either said first retainer or to said second retainer.
